(19) United States
(12) Patent Application Publication
(10) Pub. No.: US 2025/0284758 A1
(43) Pub. Date: Sep. 11, 2025

(54) CONTENT STAGE TRANSITIONING BASED ON INACTIVE DISPLAY

(71) Applicant: Capital One Services, LLC, McLean, VA (US)

(72) Inventor: Bryan TAMAYO, Allen, TX (US)

(21) Appl. No.: 18/599,828

(22) Filed: Mar. 8, 2024

(51) Int. Cl. G06F 16/958; G06F 3/0481

(52) U.S. Cl. CPC G06F 16/958; G06F 3/0481

(57) ABSTRACT

In some implementations, a content stage transitioning system may receive content interaction data, associated with a content stage of a plurality of content stages, that satisfies one or more content interaction conditions. The content stage transitioning system may receive an indication that a display associated with the content stage is inactive. The content stage transitioning system may transmit, based on the one or more content interaction conditions being satisfied and the display being inactive, an indication to transition to another content stage of the plurality of content stages.

### BACKGROUND

The Internet is a system of interconnected computer networks that enables communication between networks and devices. For example, a user device may use a web browser to fetch content, over the Internet, from a web server. The user device may display the content on a screen.

### SUMMARY

Some implementations described herein relate to a system for webpage transitioning. The system may include one or more memories and one or more processors communicatively coupled to the one or more memories. The one or more processors may be configured to receive content interaction data, associated with a webpage of a website, that satisfies one or more content interaction conditions. The one or more processors may be configured to receive an indication that a browser tab configured to display the webpage is inactive. The one or more processors may be configured to transmit, based on the one or more content interaction conditions being satisfied and the browser tab being inactive, an indication to transition to another webpage of the website.

Some implementations described herein relate to a method of content stage transitioning. The method may include receiving content interaction data, associated with a content stage of a plurality of content stages, that satisfies one or more content interaction conditions. The method may include receiving an indication that a display associated with the content stage is inactive. The method may include transmitting, based on the one or more content interaction conditions being satisfied and the display being inactive, an indication to transition to another content stage of the plurality of content stages.

Some implementations described herein relate to a non-transitory computer-readable medium that stores a set of instructions. The set of instructions includes one or more instructions that, when executed by one or more processors of a device, may cause the device to receive content interaction data, associated with a content stage of a plurality of content stages, that satisfies one or more content interaction conditions. The set of instructions includes one or more instructions that, when executed by one or more processors of the device, may cause the device to receive an indication that a display associated with the content stage is inactive. The set of instructions includes one or more instructions that, when executed by one or more processors of the device, may cause the device to transmit, based on the one or more content interaction conditions being satisfied, the display being inactive, and content stage transition feedback, an indication to transition to another content stage of the plurality of content stages. The set of instructions includes one or more instructions that, when executed by one or more processors of the device, may cause the device to receive feedback associated with the transition to the other content stage.

### BRIEF DESCRIPTION OF THE DRAWINGS

FIG. 1 is a diagram of an example associated with content stage transitioning, in accordance with some embodiments of the present disclosure.

FIG. 2 is a diagram of an example associated with data flow in a technical stack for content stage transitioning, in accordance with some embodiments of the present disclosure.

FIG. 3 is a diagram of examples associated with a user interface (UI) for content stage transitioning, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with content stage transitioning based on inactive display, in accordance with some embodiments of the present disclosure.

FIG. 6 is a flowchart of an example process associated with content stage transitioning based on an inactive display, in accordance with some embodiments of the present disclosure.

### DETAILED DESCRIPTION

The following detailed description of example implementations refers to the accompanying drawings. The same reference numbers in different drawings may identify the same or similar elements.

A user may navigate a digital content platform (e.g., a website) using a display, such as a browser tab, to complete a content journey. For example, the user may progress through a sequence or series of sections (e.g., webpages) to complete a digital transaction, registration, certification, or any other suitable operations. However, a user who has started the content journey may switch to another activity before completing the content journey. Often, the user may leave open the display (e.g., browser tab) when switching to the other activity, causing the display to become inactive.

The user may return to the content journey after any suitable length of time, such as hours, days, or even longer. Therefore, the user may have forgotten in the content journey the user left off. As a result, instead of returning to the inactive display, the user may open a separate display (e.g., another webpage) corresponding to the same or another part of the content journey as the part where the user left off. Additionally, or alternatively, the user may repeat parts of the content journey.

Repeating parts of the content journey, and/or leaving open unused displays, can consume excessive resources (e.g., computer memory, battery usage, processing power, or the like) at the user device. In some examples, the user may step away multiple times during content journey, which can result in multiple (e.g., duplicated) inactive displays and/or cause the user to repeat parts of the content journey multiple times, thereby amplifying the excessive resource consumption. Also, user engagement may suffer due to the additional effort on the part of the user to return to the part of the content journey where the user left off and/or proceed to any next steps in the content journey. As a result, the content journey may become longer for the user, and the likelihood that the user will complete the content journey is decreased.

Digital content platforms generally use static recommendation systems that suggest related content based on metadata of an article that the user is currently reading or the browsing history of the user. Such static recommendation systems can often be found at the end of an article or in a sidebar. Most static recommendation systems generate content recommendations (e.g., in the form of a pop-up) in a static form at or near the end of a webpage. A typical example of a static recommendation system is an automated pop-up (e.g., an auto-content pop-up) of a newsletter after the user has reached a given scroll percentage of a webpage. Furthermore, static recommendation systems often require manual user input (e.g., user-initiated navigation, manual selection from lists of suggested content, or the like). Thus, the next step in a content journey, and/or what is needed to progress or forward the user to the next step, may be manually determined with largely unsuccessful results.

Static recommendation systems may lack the capability to adapt in real-time to specific user engagement with content. For example, static recommendation systems may lack responsiveness to real-time user interaction. For example, content recommendations generated by static recommendation systems may not indicate whether the user has consumed certain content before directing the user and/or introduce new pathways. As a result, static recommendation systems may fail to provide a personalized navigation experience to assist a user in resuming a content journey, particularly for relatively long content journeys.

Some implementations described herein may enable automatically transitioning a user to an appropriate stage of a content journey in a display (e.g., a browser tab). In some examples, a digital content management system may transition the display to the appropriate stage based on real-time user engagement tracking and automated, intelligent navigation across various online content formats. For example, the digital content management system may use machine learning (ML), based on real-time interaction data, to predict the content to transition the user to.

In some examples, the digital content management system (e.g., a dynamic, real-time monitoring system) may cause the display to transition to the appropriate stage upon the display becoming inactive (e.g., webpage exit), which may reflect that the user has paused the content journey in lieu of another activity. In some examples, the digital content management system may transition the display to the appropriate stage (e.g., another webpage) based on the user having interacted with a sufficient portion of the current stage (e.g., a current webpage). For example, the digital content management system may monitor, in real-time, for one or more conditions to meet a completion state. The condition(s) may relate to user interaction with content on a webpage (e.g., user engagement). For example, the conditions may relate to scroll depth, hover time, or the like.

The digital content management system may, responsive to the webpage becoming inactive (e.g., responsive to the user leaving the webpage), and responsive to the completion state being met, trigger a content transition (e.g., transition the user to the next relevant content). Thus, the digital content management system may trigger content transitions based on substantial engagement with the current content and user active-to-inactive departure from the webpage. The digital content management system may transition the user automatically (e.g., without manual input from the user).

As a result, instead of opening separate (e.g., duplicate) browser tabs and/or repeating parts of the content journey, the user may resume the content journey at the same display (e.g., browser tab), thereby conserving resources at the user device. For example, the digital content management system may reduce or eliminate a need for the user to open (or leave open) additional browser tabs, duplicates, and/or old content, which may conserve computer memory, battery usage, and processing power for the user device. Also, the digital content management system may enhance user engagement on digital platforms by creating a tailored and engaging experience.

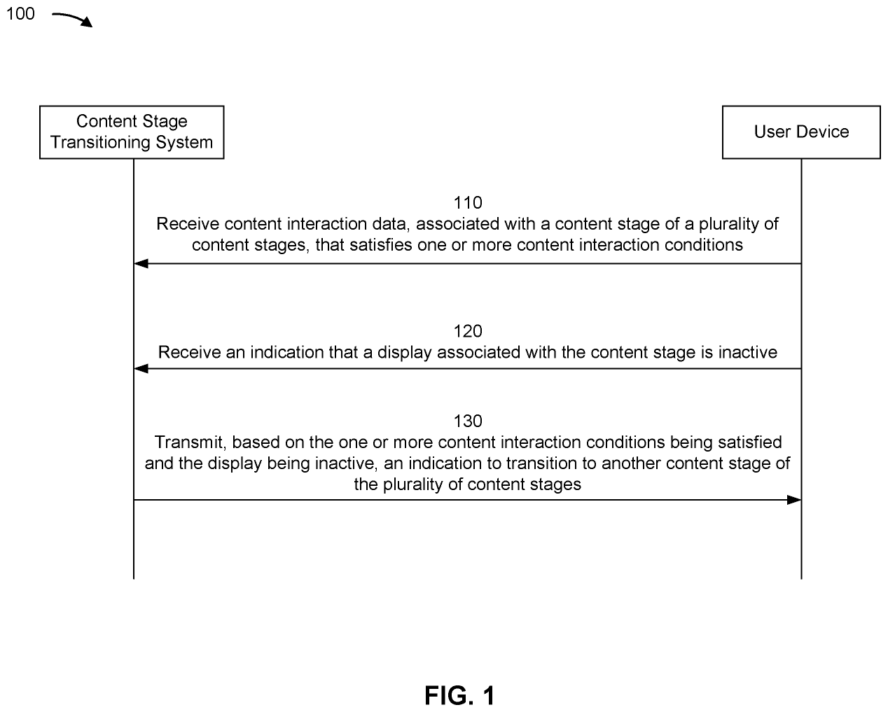

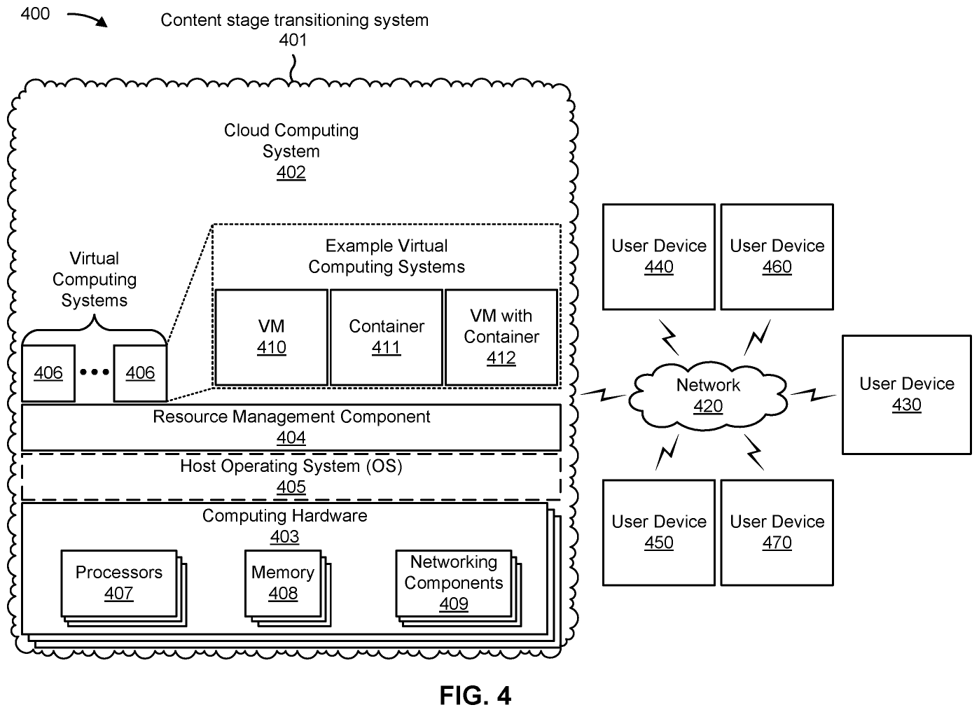

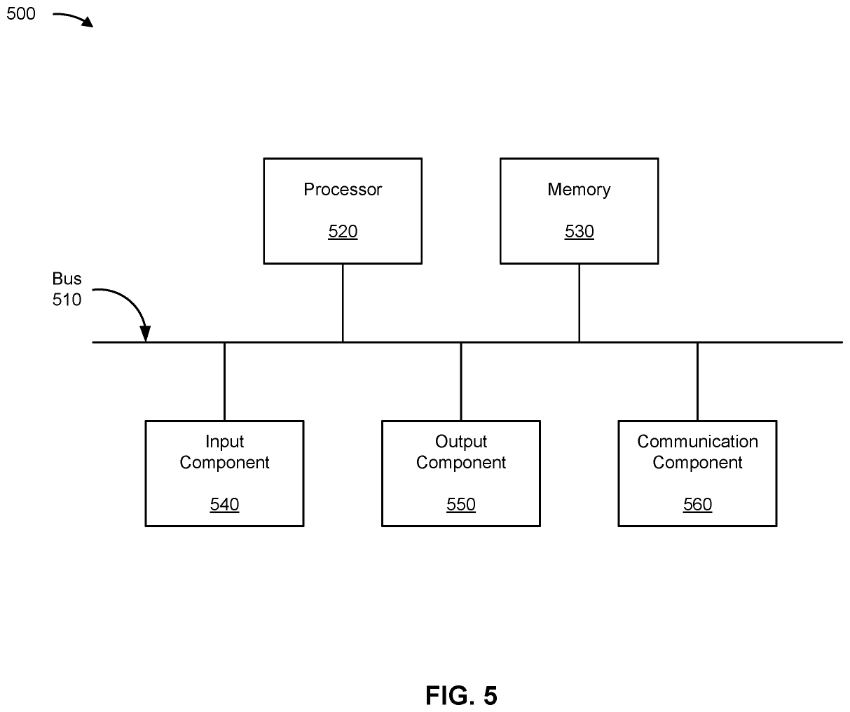

FIG. 1 is a diagram of an example 100 associated with content stage transitioning. As shown in FIG. 1, example 100 includes a content stage transitioning system (e.g., a digital content management system) and a user device. These devices are described in more detail in connection with FIGS. 4 and 5.

Initially, a user may be in the process of progressing through a plurality of content stages (e.g., a content journey). For example, each content stage may be a webpage, and the plurality of content stages may be included in a website. The user may access the website and/or webpages using a user device. For example, the user device may include a screen configured to provide one or more displays. In some examples, the screen may provide a display associated with a content stage. For example, the display may be a browser tab configured to display the webpage. As used herein, a “browser tab” may be a tab of a web browser. A user may switch between different tabs of the same web browser if the user has multiple tabs open in the web browser.

As shown by reference number 110, the user device may transmit, and the content stage transitioning system may receive, content interaction data, associated with a content stage of a plurality of content stages, that satisfies one or more content interaction conditions. The content stage may be the current content stage (e.g., a current webpage) that a user is consuming. The content interaction data may be associated with the content stage in that the content interaction data may be generated and/or collected by the content stage transitioning system while the user is consuming (e.g., interacting) with the content stage.

The content interaction data may be any suitable data that the content stage transitioning system can use to identify and/or approximate an extent to which the user has consumed content in the content stage. For example, the content interaction data may satisfy the one or more content interaction conditions (e.g., conditional states) that, together or independently, indicate a level of content consumption by the user for the content stage. The particular content interaction condition(s) that are used to indicate content consumption may vary depending on the particular content stage, the content in the content stage, or the like. For example, the content interaction condition(s) may be configurable (e.g., swapable) based on the particular webpage, webpage owner, substantive content of the webpage, content arrangement within the webpage, features of the webpage, or the like.

In some aspects, the one or more content interaction conditions may include a scroll depth threshold. In such cases, the content interaction data may include a scroll depth of the user (e.g., how far the user scrolled down the webpage). For example, the scroll depth may indicate which content on the webpage was viewable to the user. For example, the scroll depth satisfying the scroll depth threshold may indicate that the user has scrolled down (and, by proxy, consumed) a sufficient portion of the webpage to transition the user to a next webpage.

In some aspects, the one or more content interaction conditions may include an active time threshold. In such cases, the content interaction data may include an active time of the user (e.g., a length of time that the user was active on the webpage). For example, the active time satisfying the active time threshold may indicate that the user was active (and, by proxy, consuming) content for a sufficient length of time to transition the user to a next webpage.

In some aspects, the one or more content interaction conditions may include a hover time threshold. In such cases, the content interaction data may include a hover time of the user (e.g., a length of time that the user hovered over a feature (e.g., a button) on the webpage). For example, the hover time satisfying the hover time threshold may indicate that the user hovered over the feature for a sufficient length of time to transition the user to a next webpage. For example, the user hovering over a feature (e.g., a “next” button or the like) may indicate that the user has consumed sufficient content to transition the user to a next webpage.

In some aspects, the one or more content interaction conditions may include a focusable element change. A focusable element may be an element (e.g., feature) of a content stage (e.g., webpage) that can be selected to receive input from a keyboard or keyboard-like component (e.g., as opposed to receiving input from a mouse). A focusable element change may change focus from one focusable element to another focusable element. In such cases, the content interaction data may include a focusable element change performed by the user. For example, a user may switch focus between different focusable elements using a “tab” key on a keyboard, which may be referred to as a tab focus feature. The focusable element change, such as the user changing focus to a “next” button or the like, may indicate that the user has consumed sufficient content to transition the user to a next webpage.

In some aspects, the one or more content interaction conditions may include multiple content interaction conditions. For example, the content interaction data may satisfy multiple (e.g., two or more) content interaction conditions, such as a scroll depth threshold, an active time threshold, a hover time threshold, a focusable element change, user viewing of one or more pictures of a purchasable product or associated with a purchasable service, a vision-based content interaction condition (e.g., as determined based on vision tracking), or the like.

In some examples, the content stage transitioning system may receive the content interaction data from a plurality of displays. The plurality of displays may be a plurality of browser tabs that are on the same user device or different user devices. For example, the content stage transitioning system may capture content interaction data from inactive browser tabs on multiple (e.g., all) the mobile devices that a user has used to interact in a given content journey. Thus, the content stage transitioning system may track the conditional states across browser tabs by synchronizing the content interaction data across the browser tabs.

As shown by reference number 120, the user device may transmit, and the content stage transitioning system may receive, an indication that a display associated with the content stage is inactive. The display may be associated with the content stage in that the display is currently displaying the content stage. For example, the display associated with the content stage may be a browser tab configured to display a webpage. The indication that the display is inactive may be an indication that the user has opened a different browser tab, an indication that the user has not interacted with the browser tab within a given time window, or the like. The display may be considered inactive if the user has left the display open without interacting with the content provided on the display.

As shown by reference number 130, the content stage transitioning system may transmit, and the user device may receive, an indication to transition to another content stage of the plurality of content stages. For example, the other content stage may be a subsequent content stage in the content journey of the user. In some examples, the other content stage may be another webpage of the website (e.g., a next webpage in a sequence of webpages). For example, the indication to transition to the other content stage may prompt the inactive browser tab to switch from displaying the (current) webpage to the other webpage.

The particular content stage to which the user transitions may be user-specific and may vary depending on the specific content of the webpage, the content journey of the user, the purpose of the webpage, or the like. For example, if the user hovers over, but does not select, a “prequalify” button, and the content stage transitioning system is monitoring the hover state (e.g., hover time), then the content stage transitioning system may direct the user to an “about” page on the next webpage or at the end of the webpage content. Thus, the content stage transitioning system may, by monitoring configured actions and conditions and accounting for (e.g., learning from) multiple webpages, perform actions other than directing the user to a subsequent content stage within the website, such as actions including directing the user to a content stage that is a best fit for the user.

The content stage transitioning system may transmit, and the user device may receive, the indication to transition to the other content stage based on the one or more content interaction conditions being satisfied and the display being inactive. For example, the content stage transitioning system may identify the other content stage based on any suitable quantity (e.g., one, two, or more than two) content interaction conditions. For example, the content stage transitioning system may use multiple content interaction conditions (e.g., two or more conditional states) to automatically identify, learn from, and/or optimize the content progression to the next content stage for the user on the inactive webpage.

In some examples, the content stage transitioning system may perform other actions, such as caching, automated email campaigns, or the like. The content stage transitioning system may use other data associated with the user (e.g., in addition to or instead of the content interaction data), to perform such other actions.

In some aspects, the indication to transition to the other content stage may be associated with a plurality of displays (e.g., browser tabs). The indication may be associated with the plurality of displays in that the content stage transitioning system may transmit one or more instances of the indication to the plurality of displays (e.g., the content stage transitioning system may transmit the indication to one or more user devices that have at least one of the inactive browser tabs). In some examples, the plurality of displays may be inactive. For example, in cases where the user has opened multiple inactive displays, the content stage transitioning system may prompt each of the displays to transition to the other content stage. For example, the content stage transitioning system may prompt multiple inactive browser tabs that are open to transition to the appropriate webpage for the user to continue the content journey.

In some examples, any webpages that persist in inactive states may occasionally check-in with the content stage transitioning system regarding the content interaction data, such as information that the content stage transitioning system has determined (e.g., learned) regarding based on the content interaction data. For example, the content stage transitioning system may, based on the content interaction data, learn (e.g., off-webpage) where in the content journey the user is and help to synchronize the inactive displays. As a result, the content stage transitioning system may redirect the plurality of displays to the current content stage of the content journey, which may involve one or more of the displays skipping one or more content stages to arrive at the current content stage.

In some aspects, the content stage transitioning system may transmit the indication to transition to the other content stage based on content stage transition feedback. The content stage transition feedback may indicate whether, and/or to what degree, previous indications to transition to other content stages was appropriate (e.g., for the user and/or for other users). In some examples, the content stage transition feedback may be implicit (e.g., based on user interaction with content in the other content stage) or explicit (e.g., based on a user responding to a survey question or the like). The content stage transition feedback may refine the indication to transition to the other content stage (e.g., using machine learning (ML)).

In some aspects, the content stage transitioning system may receive feedback associated with the transition to the other content stage. The feedback may be associated with the transition to the other content stage in that the feedback may indicate whether, and/or to what degree, indication to transition to the other content stage was appropriate. For example, the feedback may indicate whether the user was ready to progress to the other content stage. The feedback may be implicit or explicit. The content stage transitioning system may use the content stage transition feedback to refine future indications to transition to other content stages (e.g., using ML). For example, the feedback associated with the transition to the other content stage (and/or the content stage transition feedback) may belong to an ML-based feedback loop that iteratively improves transitions to content stages facilitated by the content stage transitioning system.

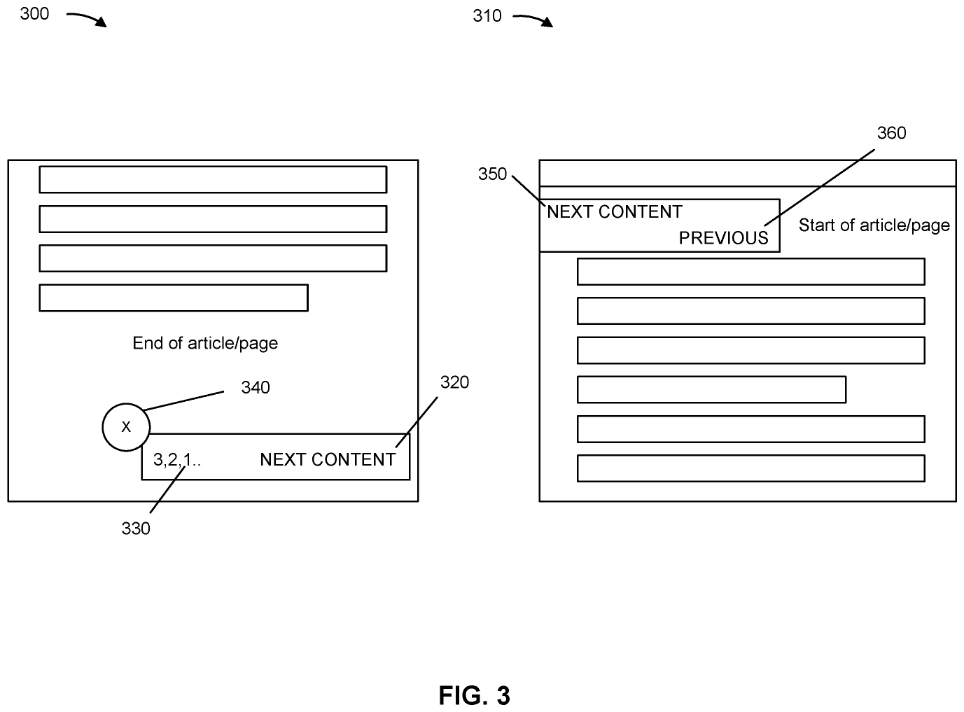

In some aspects, the content stage transitioning system may transmit an indication to display to an alert associated with the transition to the other content stage. The alert may be associated with the transition to the other content stage in that the alert may be include an indication that the content stage will transition, an indication of the content stage that will be transitioned to, an indication that the content stage has transitioned, an indication of the content stage before the transition, or the like. For example, the content stage transitioning system may to generate alert may be an automated pop-up that enables the user content journey of the webpage content to continue. Examples of alerts are illustrated in FIG. 3 and described further herein. In some examples, the content stage transitioning system may monitor two or more conditional states, determine, in the background, to transmit an indication to display to an alert, and transmit the indication to cause the user device to generate the alert at browser tabs with inactive states.

In some aspects, the content stage transitioning system may receive an indication to enable or disable content stage transitioning. Enabling content stage transitioning may involve enabling a user device to transition to the other content stage in response to receiving the indication to transition to the other content stage from the content stage transitioning system. Disabling content stage transitioning may involve disabling a user device to transition to the other content stage and/or disabling the content stage transitioning system to transmit the indication to transition to the other content stage from the content stage transitioning system. A user may enable or disable content stage transitioning before, during, or after any suitable operation described herein.

Transmitting, based on the one or more content interaction conditions being satisfied and the display being inactive, an indication to transition to another content stage of the plurality of content stages may enable the user to resume the content journey at the same display (e.g., browser tab), instead of opening separate (e.g., duplicate) browser tabs and/or repeating parts of the content journey, thereby conserving resources at the user device. For example, the content stage transitioning system may reduce or eliminate a need for the user to open (or leave open) additional browser tabs, duplicates, and/or old content, which may conserve computer memory, battery usage, and processing power for the user device.

Additionally, or alternatively, the content stage transitioning system may enhance user engagement on digital platforms by creating a tailored and engaging experience. For example, the content stage transitioning system may transition to other content stages that are contextually relevant and timely, aligning with the natural reading or browsing rhythm of the user. As a result, the content stage transitioning system may offer an automated, intuitive, seamless, and personalized user experience where content adaptation occurs in the background, thereby enhancing user engagement in dynamic digital content navigation without disrupting the browsing experience. Monitoring and tracking user behavior in one or multiple conditions to indicate (e.g., estimate) user consumption of the content and identifying the next best-fit content for user attention or action may be helpful and proactive. The content stage transitioning system may automate the content journey and record and capture the user reconnections to the content (e.g., via the next content stage), thereby helping long content journeys to progress.

The content stage transitioning system may implement techniques that are repeatable and constructive for assisting owners (e.g., content owners, website owners, webpage owners, or the like) to help users to progress in a content journey. For example, consistent usage and behavior collection (e.g., content interaction data), such as via ML, may enable the content stage transitioning system to inform page owners of stop gaps in user interface design. Thus, the content stage transitioning system may use content interaction tracking and content recommendation systems (e.g., automated pop-ups) to align with the goal of users and owners alike in optimizing content journeys.

The one or more content interaction conditions including multiple content interaction conditions may improve the accuracy of content stage transition determinations by the content stage transitioning system. For example, multiple content interaction conditions may improve accuracy of determinations regarding when the user has completed enough of a webpage to progress to another content stage, which content stage to progress to, or the like.

The indication to transition to the other content stage being associated with a plurality of displays may enable the displays to remain synchronized (e.g., across browser tabs, across user devices, or the like). By remaining up-to-date regarding where the user is in the content journey, the appropriate content stage may follow the user (e.g., across displays) and assist the user in completing the content journey.

As indicated above, FIG. 1 is provided as an example. Other examples may differ from what is described with regard to FIG. 1.

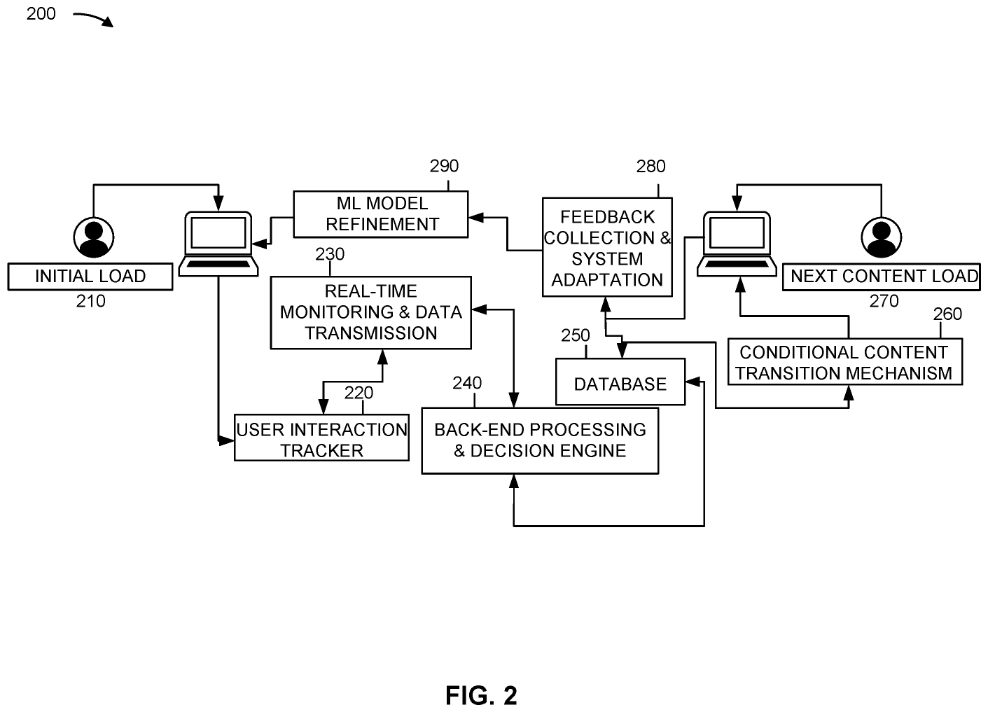

FIG. 2 is a diagram of an example 200 associated with data flow in a technical stack for content stage transitioning. As explained further herein, example 200 may involve setting up content interaction tracking modules, performing backend monitoring of content interaction data, and analyzing the monitored content interaction data using ML to feed the next best-fit content to the user device.

As shown by reference number 210, a user may provide an initial load to a user device. For example, the initial load may be a user interaction with content in a content stage of a content journey. For example, the initial load may involve the user engaging with the content through browsing behaviors, such as scrolling, reading, or the like.

A user interaction tracker 220 may use front-end interface design technology (e.g., hypertext markup language 5 (HTML5), cascading style sheets 3 (CSS3), or the like) and real-time user interaction tracking technology (e.g., JavaScript or the like). The user interaction tracker 220 may reside on the user device. The user interaction tracker 220 may, in real-time, track user interactions generated by the initial load. For example, the user interaction tracker 220 may track one or more interaction conditions (e.g., interaction states), such as scroll depth, time on page, tab focus changes, or the like. The user interaction tracker 220 may enhance user engagement through direct observation of browsing behaviors.

A real-time monitoring and data transmission function 230 may, in real-time, continuously monitor and record user interactions (e.g., using JavaScript). The real-time monitoring and data transmission function 230 may reside on the user device. In some examples, the real-time monitoring and data transmission function 230 may capture the resulting content interaction data silently (e.g., without explicitly notifying the user) and continuously as the user engages with the content. The real-time monitoring and data transmission function 230 may transmit the content interaction data to the content stage transitioning system (e.g., a server). For example, the real-time monitoring and data transmission function 230 may use WebSocket, asynchronous JavaScript and extensible markup language (AJAX), or the like to transmit the content interaction data to the server. Thus, the real-time monitoring and data transmission function 230 may enable capturing and responding to user engagement in real-time.

A back-end processing and decision engine 240 may process the content interaction data (e.g., user behavior data) and predict next suitable content for the user. The back-end processing and decision engine 240 may reside at the server. The server (e.g., server environment) may use Python for advanced data handling. The server may contain an ML framework that employs TensorFlow to analyze the content interaction data and predict the next suitable content (e.g., using an ML-based content prediction model). The back-end processing and decision engine 240 may process the content interaction data in the background, preparing to act after the user leaves the webpage (e.g., after the browser tab becomes inactive), thereby offering a dynamic, personalized navigation experience.

In some examples, the back-end processing and decision engine 240 may contain or interact with a database management system that is responsible for a database 250. The database 250 may be configured to store content interaction data, content information, or the like. The database 250 may be a structured query language (SQL) database, a non-SQL (NoSQL) database, or the like.

A conditional content transition mechanism 260 may activate, behind-the-scenes, a transition to other content upon the user leaving the webpage. The conditional content transition mechanism 260 may reside at the server and/or at the user device. For example, the conditional content transition mechanism 260 may use server-side Python scripts to handle content delivery to the user device based on dual conditions (e.g., user engagement and webpage exit) being met. Additionally, or alternatively, the conditional content transition mechanism 260 may use AJAX and JavaScript at the user device to prepare and facilitate a seamless transition to the other content based on an indication from the server that the conditions have been met. As a result, the conditional content transition mechanism 260 may automate content adaptation and thereby enhance user experience.

As shown by reference number 270, the user may provide a subsequent content load to the user device. The user may provide the subsequent content load after the user device has transitioned to the other content stage. For example, the subsequent content load may involve the user engaging with the newly-loaded, transitioned-to content through browsing behaviors, such as scrolling, reading, or the like.

A feedback collection and system adaption function 280 may collect and analyze user feedback. The user may provide the user feedback by interacting with the newly-loaded content. The user feedback may be implicit and/or explicit. In some examples, the feedback collection and system adaption function 280 may reside at the server and/or at the user device. For example, the feedback collection and system adaption function 280 may use JavaScript and AJAX or WebSocket to collect (e.g., capture) and send user feedback. Additionally, or alternatively, server-side Python scripts may evaluate the user feedback for continuous system improvement, thereby helping to ensure that the content recommendations (e.g., content stage transitions) evolve with user preferences.

An ML model refinement function 290 may continuously refines the content prediction model with incoming user interaction data (e.g., the user feedback). The ML model refinement function 290 may reside at the server. In some examples, the ML model refinement function 290 may use Python and TensorFlow to refine the content prediction model. Thus, ongoing user interaction data may contribute to (e.g., advance) the evolving accuracy and personalization of the recommendation model (e.g., the back-end processing and decision engine 240).

As indicated above, FIG. 2 is provided as an example. Other examples may differ from what is described with regard to FIG. 2.

FIG. 3 is a diagram of examples 300 and 310 associated with a UI for content stage transitioning. In some examples, the UI (e.g., a graphical UI (GUI)) may be generated, at the user device (e.g., on a display or browser tab), in response to an indication received from the conditional content transition mechanism 260 (FIG. 2).

Example 300 shows a display that includes a current content stage of a user in a content journey. As shown, the user has reached the end of an article or webpage. Therefore, the content interaction data generated by user interaction with the content at the current content stage has satisfied one or more content interaction conditions. For example, the content has reached two or more modes, which may be sufficient to auto-direct the user to the next content in the content journey. However, in this example, the display has become inactive before the user continued in the content journey.

As shown by reference number 320, the user device may generate, at the end of the article or webpage, a UI overlay (e.g., a UI dialog box) that indicates the next content to which the user is to be auto-transitioned. The UI overlay may load upon the user device receiving an indication that the content interaction data satisfies the content interaction condition(s). Thus, the UI overlay may notify the user that the user is to be progressed to the next content stage in the content journey.

As shown by reference number 330, the UI overlay may include a countdown timer. The countdown timer may provide a visual countdown of the remaining time until the next content (e.g., webpage) loads. For example, the user device may load the next content upon reaching the end of the countdown. Thus, the UI overlay may notify the user when the user is to be progressed to the next content stage in the content journey.

As shown by reference number 340, the UI overlay may include a “disable” button that enables the user to disable content stage transitioning. For example, the “disable” button may be a “close” or “stop” indication that, if selected (e.g., clicked) by the user, prevents auto-navigation to the next content. Thus, the UI overlay may indicate, to the user, that content stage transitioning is a feature that can be optionally turned off.

Example 310 shows the display after the next content loads. As shown by reference number 350, the user device may generate, at the top of next article or webpage, a UI overlay (e.g., a UI dialog box) that indicates the content to which the display has transitioned (“next content”). In some examples, the UI overlay may load upon reactivation of the page tab, and may serve as an alert (e.g., an alert-type dialog). Thus, the UI overlay may notify the user of the content that has auto-loaded while the browser tab was inactive.

As shown by reference number 360, the UI overlay may include an option (e.g., button) that, when selected, redirects the user to the previous content shown in example 300. Thus, the UI overlay may notify the user that the user can revisit the previous content.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a content stage transitioning system 401, which may include one or more elements of and/or may execute within a cloud computing system 402. The cloud computing system 402 may include one or more elements 403-412, as described in more detail below. As further shown in FIG. 4, environment 400 may include a network 420 and/or one or more of user devices 430-470. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the content stage transitioning system 401 may include one or more elements 403-412 of the cloud computing system 402, may execute within the cloud computing system 402, and/or may be hosted within the cloud computing system 402, in some implementations, the content stage transitioning system 401 may not be cloud-based (e.g., may be implemented outside of a cloud computing system) or may be partially cloud-based. For example, the content stage transitioning system 401 may include one or more devices that are not part of the cloud computing system 402, such as device 500 of FIG. 5, which may include a standalone server or another type of computing device. The content stage transitioning system 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The user devices 430-470 may include one or more devices capable of receiving, generating, storing, processing, and/or providing information associated with content stage transitioning as described elsewhere herein. The user device 430-470 may include a communication device and/or a computing device. For example, the user device 430-470 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with content stage transitioning based on inactive display. The device 500 may correspond to the content stage transitioning system 401. In some implementations, the content stage transitioning system 401 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

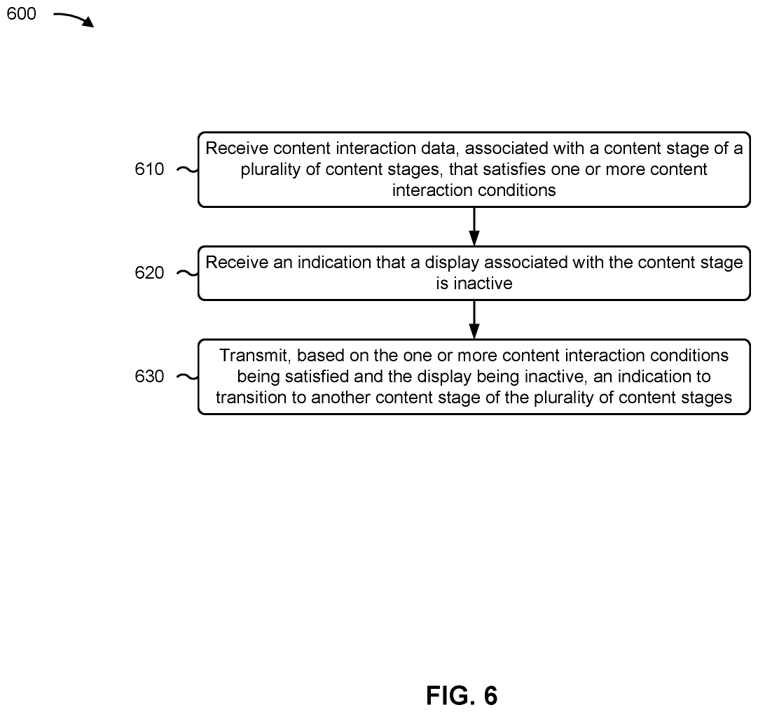

FIG. 6 is a flowchart of an example process 600 associated with content stage transitioning based on an inactive display. In some implementations, one or more process blocks of FIG. 6 may be performed by the content stage transitioning system 401. In some implementations, one or more process blocks of FIG. 6 may be performed by another device or a group of devices separate from or including the content stage transitioning system 401, such as the user devices 430-470. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving content interaction data, associated with a content stage of a plurality of content stages, that satisfies one or more content interaction conditions (block 610). For example, the content stage transitioning system 401 (e.g., using processor 520, memory 530, input component 540, and/or communication component 560) may receive content interaction data, associated with a content stage of a plurality of content stages, that satisfies one or more content interaction conditions, as described above in connection with reference number 110 of FIG. 1. As an example, the content stage may be a current webpage that a user is consuming.

As further shown in FIG. 6, process 600 may include receiving an indication that a display associated with the content stage is inactive (block 620). For example, the content stage transitioning system 401 (e.g., using processor 520, memory 530, input component 540, and/or communication component 560) may receive an indication that a display associated with the content stage is inactive, as described above in connection with reference number 120 of FIG. 1. As an example, the indication that the display is inactive may be an indication that the user has opened a different browser tab, an indication that the user has not interacted with the browser tab within a given time window, or the like.

As further shown in FIG. 6, process 600 may include transmitting, based on the one or more content interaction conditions being satisfied and the display being inactive, an indication to transition to another content stage of the plurality of content stages (block 630). For example, the content stage transitioning system 401 (e.g., using processor 520, memory 530, and/or communication component 560) may transmit, based on the one or more content interaction conditions being satisfied and the display being inactive, an indication to transition to another content stage of the plurality of content stages, as described above in connection with reference number 130 of FIG. 1. As an example, the indication to transition to the other content stage may prompt the inactive browser tab to switch from displaying the current webpage to another webpage.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1-3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for webpage transitioning, the system comprising:
one or more memories; and
one or more processors, communicatively coupled to the one or more memories, configured to:
receive content interaction data, associated with a webpage of a website, that satisfies one or more content interaction conditions;
receive an indication that a browser tab configured to display the webpage is inactive; and
transmit, based on the one or more content interaction conditions being satisfied and the browser tab being inactive, an indication to transition to another webpage of the website.

2. The system of claim 1, wherein the one or more content interaction conditions include a scroll depth threshold.

3. The system of claim 1, wherein the one or more content interaction conditions include an active time threshold.

4. The system of claim 1, wherein the one or more content interaction conditions include a hover time threshold.

5. The system of claim 1, wherein the one or more content interaction conditions include a focusable element change.

6. The system of claim 1, wherein the one or more content interaction conditions include multiple content interaction conditions.

7. A method of content stage transitioning, comprising:
receiving content interaction data, associated with a content stage of a plurality of content stages, that satisfies one or more content interaction conditions;
receiving an indication that a display associated with the content stage is inactive; and
transmitting, based on the one or more content interaction conditions being satisfied and the display being inactive, an indication to transition to another content stage of the plurality of content stages.

8. The method of claim 7, wherein the one or more content interaction conditions include one or more of: a scroll depth threshold, an active time threshold, a hover time threshold, or a focusable element change.

9. The method of claim 7, wherein the one or more content interaction conditions include multiple content interaction conditions.

10. The method of claim 7, further comprising:
receiving feedback associated with the transition to the other content stage.

11. The method of claim 7, wherein transmitting the indication to transition to the other content stage includes transmitting the indication to transition to the other content stage based on content stage transition feedback.

12. The method of claim 7, further comprising:
transmitting an indication to display to an alert associated with the transition to the other content stage.

13. The method of claim 7, further comprising:
receiving an indication to enable or disable content stage transitioning.

14. The method of claim 7, wherein the indication to transition to the other content stage is associated with a plurality of displays.

15. A non-transitory computer-readable medium storing a set of instructions, the set of instructions comprising:
one or more instructions that, when executed by one or more processors of a device, cause the device to:
receive content interaction data, associated with a content stage of a plurality of content stages, that satisfies one or more content interaction conditions;
receive an indication that a display associated with the content stage is inactive;
transmit, based on the one or more content interaction conditions being satisfied, the display being inactive, and content stage transition feedback, an indication to transition to another content stage of the plurality of content stages; and
receive feedback associated with the transition to the other content stage.

16. The non-transitory computer-readable medium of claim 15, wherein the one or more content interaction conditions include one or more of: a scroll depth threshold, an active time threshold, a hover time threshold, or a focusable element change.

17. The non-transitory computer-readable medium of claim 16, wherein the one or more content interaction conditions include multiple content interaction conditions.

18. The non-transitory computer-readable medium of claim 15, wherein the one or more instructions, when executed by the one or more processors, further cause the device to:
transmit an indication to display to an alert associated with the transition to the other content stage.

19. The non-transitory computer-readable medium of claim 15, wherein the one or more instructions, when executed by the one or more processors, further cause the device to:
receive an indication to enable or disable content stage transitioning.

20. The non-transitory computer-readable medium of claim 15, wherein the indication to transition to the other content stage is associated with a plurality of displays.
